(19) United States
(12) Patent Application Publication
(10) Pub. No.: US 2014/0058782 A1
(43) Pub. Date: Feb. 27, 2014

(54) INTEGRATED COLLABORATIVE SCIENTIFIC RESEARCH ENVIRONMENT

(71) Applicant: MARK GRAVES, JR., Indianapolis, IN (US)

(72) Inventor: MARK GRAVES, JR., Indianapolis, IN (US)

(21) Appl. No.: 13/591,750

(22) Filed: Aug. 22, 2012

(51) Int. Cl. G06F 17/18; G06Q 10/06; G06F 19/00

(52) U.S. Cl. 705/7.23; 702/179; 702/19; 702/32

(57) ABSTRACT

An integrated scientific research environment includes a method and system of conducting a standardized, collaborative scientific research project. Researchers utilize the integrated scientific research environment to conduct experiments in which information is generated, analyzed, verified, and published in a distributed computing infrastructure that allows for multiple users to work together on experiments and scientific research projects. Multiple modules create a literature review and a research protocol, enable verification and analysis of experiment results, and prepare results for publication to add to existing knowledge in the field of the experiments conducted.

### CROSS REFERENCE TO RELATED PATENT APPLICATIONS

Not applicable.

### STATEMENT REGARDING FEDERALLY-SPONSORED RESEARCH OR DEVELOPMENT

Not applicable.

### FIELD OF THE INVENTION

The present invention relates to integrating collaboration in a scientific research environment. Specifically, the present invention includes methods and systems of conducting a standardized, collaborative scientific research project that allows for input of data, linking of data to conduct data processing and analysis in the conduct of experiments, document generation, and verification across a distributed computing infrastructure that allows for multiple user participation.

### BACKGROUND OF THE INVENTION

Most types of scientific research share common tasks which follow the well-known scientific method. These common tasks include asking a question, formulating a hypothesis, reviewing relevant knowledge, designing an experiment, gathering resources, conducting the experiment, collecting data, analyzing results, and publishing the results. These published results are then used as part of the relevant knowledge on which further experiments are based.

Commonly where computerized resources for performing the tasks of the scientific method are employed, many different and disparate tools are utilized. Regardless of the tools used, however, each such resource deals with documents and data. Documents are created, edited, stored, organized, and searched, and data is input, stored, organized, retrieved, and analyzed. These two basic types of information have vastly different embodiments, but are each used in three processes common to every scientific research project conforming to the scientific method: conducting background research on a topic, performing one or more experiments, and adding to existing scientific knowledge through paper publication.

Conducting background research involves acquiring background knowledge usually contained in published articles. Such published articles are typically stored in online databases or paper libraries, and are found using computerized search engines or physical searching. Researchers review such articles and annotate and categorize them, typically using document manipulation software.

Performance of one or more experiments, which is another major part of research projects as noted above, involves building on the knowledge obtained through background research by conducting experiments. Experiments are essentially a series of measurements which gather data. For the measurements to be of maximum utility, they should be carefully thought through, performed in a precise way, and the resulting data recorded. Recording of results requires some form of input mechanism, such as in a printed form. Result data are of maximum utility for drawing conclusions if they can be compared to other data. This is typically done through statistical analyses which require the results to be quantified. Such analysis is used, for example, to describe the mathematical relationships of the quantified results.

Another common process in scientific research project involves adding to the existing body of scientific knowledge through publication of results, usually in the form of a paper or article. In a computerized environment, mathematical results and qualitative analyses are described in words and linked to the ideas and background knowledge of other researchers using logic. These words and logic are put into a paper using document editing software. The document is then published as a scientific article, and the cycle begins again.

The existing art therefore contemplates that computerized applications are available for conducting a scientific research project. However, the existing art does not include any solution for such applications to work together for integrating the above processes and others attendant to conducting a scientific research project by linking data generated from each part and making such data available for review, analysis, comment, verification and publication, to offer researchers an end-to-end solution. The existing art also does not offer a method of standardizing a scientific research project by having such applications communicate with each other in the above processes to offer researchers the ability to generate standardized procedures, documents, and work product across the entire project such that the input and output of one experiment to be used as the input of a further experiment.

### BRIEF SUMMARY OF THE INVENTION

It is therefore one object of the present invention to provide an end-to-end solution for conducting a scientific research project. It is also an object of the present invention to integrate and standardize multiple processes by linking data generated from each part of a scientific research project and provide such data for review, analysis, comment, verification and publication. It is further an object of the present invention to provide researchers with the ability to communicate and collaborate in a distributed computing infrastructure so that they can contribute across the entire scientific research project to produce results. Lastly, it is an object of the present invention to provide a method for the input and output of one experiment to be used as the input of a further experiment.

The present invention is, in one embodiment, a computer application that serves as a standardized framework for communication between and among various applications and users to conduct collaborative scientific research. The present invention employs and integrates communication and content management systems customized to meet the security and functional needs of performing scientific research in an online, distributed computing infrastructure.

Communication and collaboration in the present invention are embodied in a social networking aspect that allows for the construction of a profile with personal information, for control of a list of other users with access to their information, and for enabling communication or other collaborative interaction among users. Collaboration may be restricted, so as to selectively limit user access to data and collaboration. Regardless, all described processes are considered collaborative processes with user access control. They are also embodied in a content management aspect that allows for reviewing, publishing, editing, modifying, and verifying content as well as site maintenance by disparate users from a centralized portal. Content management also provides a collection of procedures used to manage workflow in the collaborative environment.

The present invention is also, in another embodiment, a method of integrating multiple tasks to conduct a collaborative scientific research project, comprising linking data structures representing multiple data inputs that define background research, and that define variables representing an idea to be tested in one or more experiments, participation in the one or more experiments, at least one method of measurement for analysis of the variables and participation, and a time course for the at least one method of measurement, and that define relationships among the variables, relating the linked data structures with one or more statistical measures selected by to perform analytical data processing on the multiple data inputs to permit to generate customized quantifiable results of data based upon the at least one method of measurement in the one or more experiments, and a comparison of data using one or more additional statistical measures, translating defined variables and linked data structures related with one or more statistical measures and compared with the one or more additional statistical measures to generate one or more documents capable of being accessed and edited by multiple users across a distributed computing platform so that the one or more experiments are collaboratively conducted in a scientific research project and generating at least one set of output data representative of compared quantifiable results of the scientific research project.

In another embodiment, the present invention is a method of conducting standardized experiments in a collaborative scientific research project, comprising generating a background research library accessible by multiple users during conduct of one or more experiments in a scientific research project and creating a comparison of background research documents relative to the one or more experiments in the scientific research project from input data identifying the background research documents and representative of at least one issue relative to the one or more experiments, analyzed in response to instructions provided for categorizing the background research library, building a research protocol to guide conduct of the one or more experiments from input data representative of multiple input categories at least including experiment variables, participants, measurement methods, and time course, defining relationships between the input data representative of multiple input categories, and relating linked data structures representing at least the input data representative of multiple input categories and the relationships between the input data representative of multiple input categories with one or more selected statistical measures to perform analytical data processing on the input data representative of multiple input categories to permit the one or more users to generate customized quantifiable results of data based upon one or more measurements and a comparison of data using one or more additional statistical measures so that the one or more experiments are collaboratively conducted in a scientific research project, creating documents for organizing at least the input data representative of multiple input categories, the input data identifying the background research library, and the one or more measurements to be taken based upon the measurement methods from linked data structures so that the multiple users are capable of collaboratively reviewing, editing, analyzing and verifying the quantifiable results, and publishing the quantifiable results to add to existing scientific knowledge relative to the scientific research project.

In still another embodiment, the present invention is an integrated system for collaboration in a scientific research project, comprising a set of modules comprising an online, integrated system for collaboration in a scientific research project, the plurality of modules at least including a literature review module, a research protocol building module, a verification module, and a publishing module, one or more linked data structures each comprising a set of data records linked together in a distributed computing environment and organized so that the set of modules comprising the online, integrated system communicate with each other to populate documents across the set of modules and allow multiple users to communicate with each other, and review, modify, comment, verify, and publish the documents from any remote location, and a statistical analysis module from which the one or more users select one or more statistical measures to perform data processing functions on relationships between defined variables input by the one or more users.

In yet another embodiment, the present invention is a method of communication between the multiple tasks or tools involved in conducting a scientific research project. Such a method of communication may include linking data structures representing multiple data inputs that define background research, and that define variables representing an idea to be tested in one or more experiments, participation in the one or more experiments, at least one method of measurement for analysis of the variables and participation, and a time course for the at least one method of measurement, relating the linked data structures with one or more statistical measures selected by to perform analytical data processing on the multiple data inputs, translating defined variables and linked data structures related with one or more statistical measures and compared with the one or more additional statistical measures, and generating at least one set of output data representative of compared quantifiable results of the scientific research project. Such a method of communication may also include, in still another embodiment, generating a background research library accessible by multiple users during conduct of one or more experiments in a scientific research project and creating a comparison of background research documents relative to the one or more experiments in the scientific research project, building a research protocol to guide conduct of the one or more experiments from input data representative of multiple input categories, defining relationships between the input data representative of multiple input categories, and relating linked data structures representing at least the input data representative of multiple input categories and the relationships between the input data representative of multiple input categories with one or more selected statistical measures to perform analytical data processing on the input data representative of multiple input categories, creating documents for organizing at least the input data representative of multiple input categories, and publishing the quantifiable results to add to existing scientific knowledge relative to the scientific research project.

Other objects, embodiments, features and advantages of the present invention will become apparent from the following description of the embodiments, taken together with the accompanying drawings, which illustrate, by way of example, the principles of the invention.

### BRIEF DESCRIPTION OF THE SEVERAL VIEWS OF THE DRAWINGS

The accompanying drawings, which are incorporated in and constitute a part of this specification, illustrate several embodiments of the invention and together with the description, serve to explain the principles of the invention.

FIG. 1 is a block diagram of general system components according to one embodiment of the present invention;

FIG. 2 is a block diagram of a general system flow for interrelated data entered into and manipulated according to one embodiment of the present invention;

FIG. 3 is a pictorial representation of available documents to be selected by a user presented in a graphical user interface according to one embodiment of the present invention;

FIG. 4 is a pictorial representation of available projects to be selected by a user presented in a graphical user interface according to one embodiment of the present invention;

FIG. 5 is a pictorial representation of available items to be selected by a user for a specific project presented in a graphical user interface according to one embodiment of the present invention;

FIG. 6 is a pictorial representation of selected measurements for a specific project presented in a graphical user interface according to one embodiment of the present invention;

FIG. 7 is a pictorial representation of selected metrics for a specific project presented in a graphical user interface according to one embodiment of the present invention;

FIG. 8 is a pictorial representation of a table of research items in a literature review presented in a graphical user interface according to one embodiment of the present invention;

FIG. 9 is a pictorial representation of a study measurements for a specific project presented in a graphical user interface according to one embodiment of the present invention; and

FIG. 10 is a pictorial representation of collections for review and creation for a specific project in a graphical user interface according to one embodiment of the present invention.

### DETAILED DESCRIPTION OF THE INVENTION

In the following description of the present invention reference is made to the accompanying figures which form a part thereof, and in which is shown, by way of illustration, exemplary embodiments illustrating the principles of the present invention and how it is practiced. Other embodiments will be utilized to practice the present invention and structural and functional changes will be made thereto without departing from the scope of the present invention.

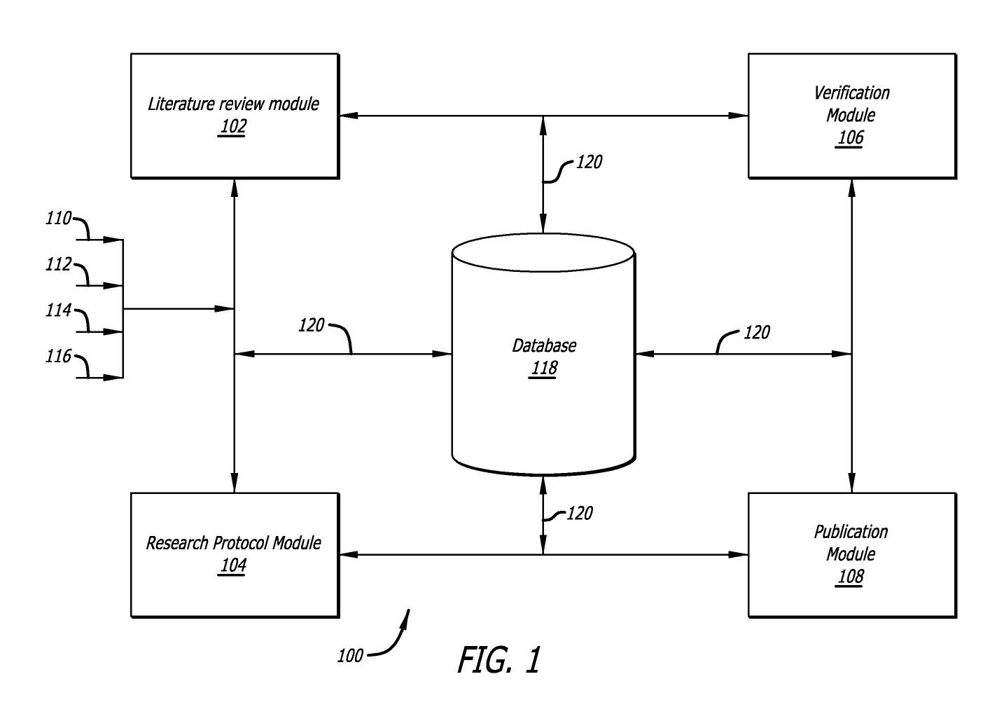

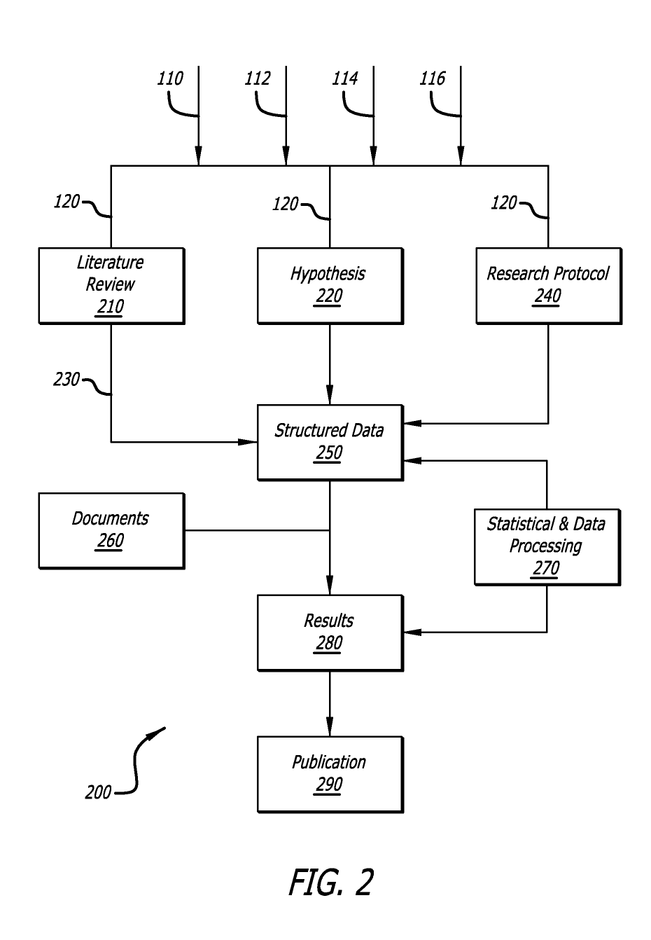

FIG. 1 is a block diagram overview of general system components of the present invention, and FIG. 2 is a block diagram overview depicting a general program flow for interrelated data entered into and processed in a system and method according to the present invention, and steps in the process of conducting an end-to-end collaborative and integrative scientific research project. In FIG. 1 and FIG. 2, an integrated scientific research environment 100 is a system for collaboration in a scientific research project 200 according to the present invention, and is generally comprised at least of a literature review module 102, a research protocol building module 104, a verification module 106, and a publishing module 108. The flow of FIG. 2 in a method of conducting a collaborative scientific research project 200 begins with measured data representative of an idea 110 for one or more experiments 230, and information relative to existing knowledge and variables 112 relative to the conduct of the experiments 230. Once such measured data representative of an idea 110 and variables 112 are entered, users of the present invention then provide definitions 114 of variables 112 and create relationships 116 between the variables 112. All of this measured data, structured by the definitions 114 and relationships 116, is stored in one or more database locations 118.

The variables 112 contemplated in the present many take many forms, and are highly dependent on the type of experiments 230 to be performed as well as the type of scientific research project 200 being conducted. The variables 112 at least represent numerous characteristics of the idea 110 to be tested in one or more experiments 230, including but not limited to participation in the one or more experiments 230, at least one method of measurement for analysis of the variables 112 and participation, and a time course for the at least one method of measurement.

The present invention is configured to create linked data structures 120 from different types of data entered by the multiple users. Such types of data include the data representative of an idea 110 for experiment 230, as well as data representative of background knowledge of the scientific research project 200, which is relative to building a library of existing knowledge for the scientific research project 200 in the literature review module 102. Other types of data forming linked data structures 120 to be processed includes variables 112, and files, protocols, results from experiments 230, and any other type of data that may be utilized by the present invention.

Referring to the flow of data in FIG. 2, freeform information acquired in the form of observations from documents and used by researchers as the basis for the idea 110 for experiment 230 is provided, together with definition 114 for the variables 112, as data inputs 110, 112, and 114 to the system and method of the present invention. This develops a background research library and literature review 210 by the literature review module 102, develops an experimental hypothesis 220 as the basis for one or more experiments 230, and builds a research protocol 240 by the research protocol building module 104. Output data relative to the literature review 210, the hypothesis 220, the one or more experiments 230, and the research protocol 240 is then structured into data inputs 250 that are then processed with one or more data processing functions represented at least by statistical measures 270 identified by and selected by users to translate them into quantifiable results that are understandable and actionable by those conducting the one or more experiments 230, and which will populate documents 260 forming the basis from which all users will work within the system. This results in a quantifiable and verifiable data collection 280, which is further structured into experimental results data by the verification module 104 as further data processing functions represented by statistical measures 270 are applied to assess elemental relationships among the data. The outcome of this is then further transformed into words for publication 290 in the publication module 108, and becomes further freeform information for generating further ideas in other researchers. The linked data structures 120 allow this data to flow through the present invention so that the various modules of the present invention are capable of accessing necessary data to perform the desired analytic functions, and to allow users to access, review, edit, modify, analyze, verify, and publish the experimental data in a distributed computing infrastructure.

A literature review 210 may also be considered an experiment 230, and therefore may also include variables 112 that serve as measured data for input into the present invention. In the context of a literature review 210, variable data may be embodied in numerical data and observations by researchers. Therefore, it is to be understood that variables 112 may be representative of many different sources of information.

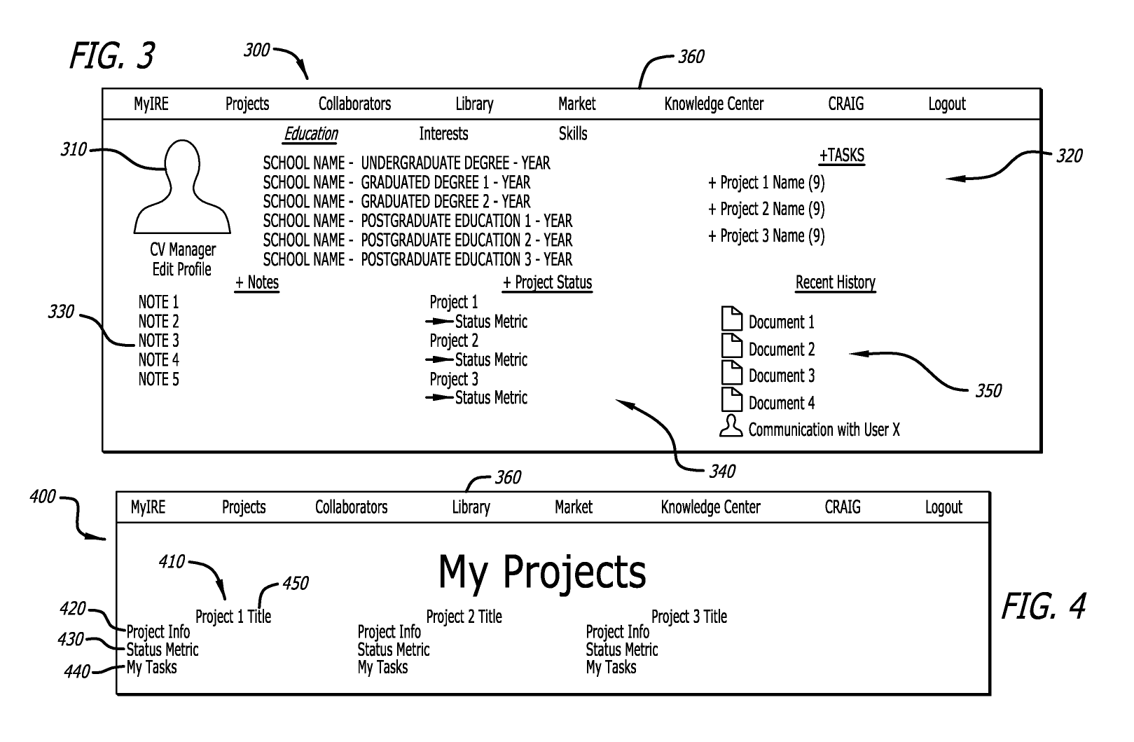

FIG. 3 is a diagram depicting available documents in sections presented to one or more users or researchers in a graphical user interface 300 through which the various features of the present invention can be accessed and utilized. The present invention is intended to be a collaborative environment in which all information entered is capable of being shared. To ensure confidentiality and privacy, each method of sharing is controlled by the user, similar to access control groups or access control lists. The present invention is also intended to be a robust, integrated environment that provides as much information as possible to users about activities attendant to the conduct of the one or more experiments 230. For example, all processes have automated audit capacity, so that every time a user updates the one or more database locations 118, it creates a history of all the updates and records the user who undertook the update, and the date and time of the update, and any notation made about why the update was performed.

FIG. 3 is representative of a home page in an online portal through which a user collaborates after accessing the interface 300. A user may be able to select from a number of different sections, such as for example a Profile section 310, a Tasks section 320, a Notes section 330, a Project Status section 340, and a listing of documents recently edited in a Recent History section 350. A number of pull-down menus 360 may also be available on the interface 300, such as those for MyIRE (which is an acronym for My Integrated Research Environment), Projects, Collaborators, Library, Market, Knowledge Center, CRAIG (an acronym for Computerized Research Artificial Intelligence Guide), and Logout as shown in FIG. 3.

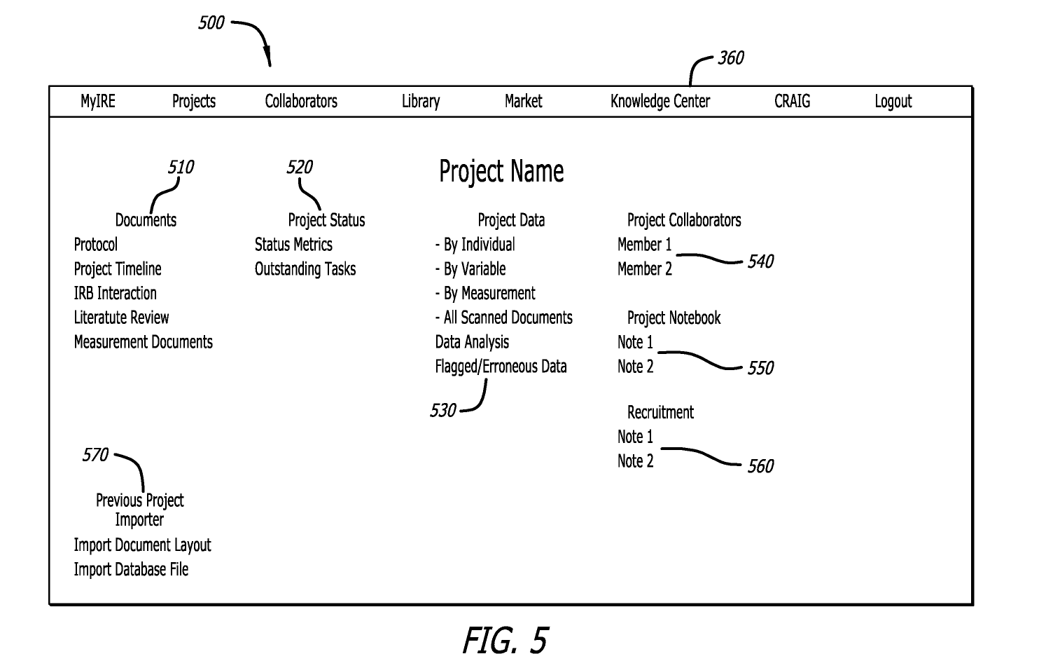

A user selecting a Project Status link from the Project Status section 340, or a scientific research project 200 from the Projects pull-down menu of menus 360, may be transferred to a specific Projects interface 400 as shown in FIG. 4. This interface 400 lists each pending project 410 and additional information relative to each scientific research project 200, such as general project information 420, a status metric 430, and tasks 440 to be performed. Selecting an individual project from its title 450 takes the user to a project-specific interface 500 as shown in FIG. 5. From the project-specific interface of FIG. 5, users may access data about each scientific research project 200, the data being linked together as in FIG. 2 to provide the user with the ability to view all information about each scientific research project 200, apply customizable statistical analyses to arrive at related, structured data inputs 250 for documents 260 and further data processing functions for comparison of the resulting experimental data.

As shown in FIG. 5, the user may select at least from a Documents section 510, a Project Status section 520, a Project Data section 530, a Project Collaborators section 540, a Project Notebook Section 550, a Recruitment section 560, and a Previous Project Importer section 570. Each of these sections takes the user to a different interface from where specific project data can be viewed and accessed.

The Documents section 510 of the project-specific interface 500 makes available to the user information about the protocol overview of the scientific research project 200, the project timeline, Independent Review Board interaction and documents, the literature review, and measurement documents. Similarly, the Project Data section 530 of the project-specific interface 500 makes available to the user information about data relative to the scientific research project 200, conveyed by one of individual, variable, and measurement, as well as offering a way to view all scanned documents, perform further data analysis as per FIG. 2, and view flagged or erroneous data.

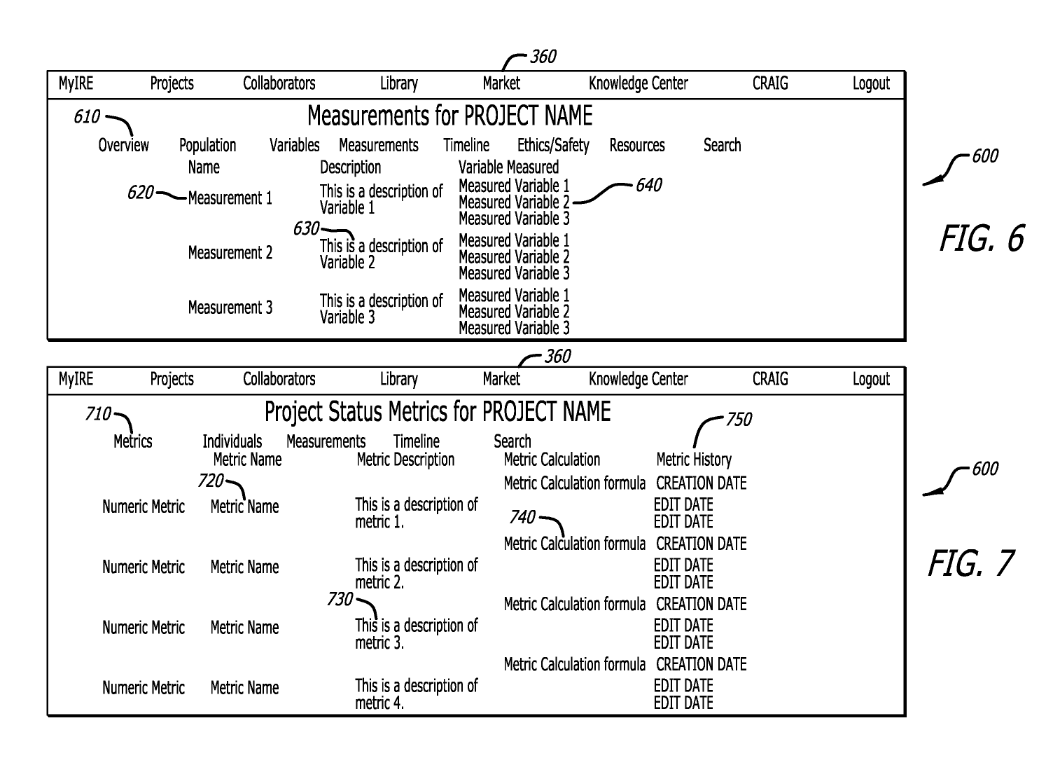

A user selecting, for example, information about Protocol Overview is transferred interface 600 shown in FIG. 6. Interface 600 presents the user with tabbed sections 610 that allow the user to view information related to the one or more experiments 230, such as Population, Variables, Measurements, Timeline, Ethics and Safety, Resources, and Search. Menu choices within each tab allow the user to click on additional information. Interface 600 shows the “Measurements”, which lists the various measurements 620 selected by the user for the research protocol 240, together with a description 630 and the variables 640 to be measured. The user can therefore easily access information about data to be translated into quantifiable information through the linked data structures 120.

Selectable menu items in Project Data section 530 of the interface 500 shown in FIG. 5, as noted above, make available data that has been translated into quantifiable information from statistical measures 270 applied to structured data 250 through the linked data structures 120. Users selecting on any one of these menu items are transferred to a data-specific interface 700 as shown in FIG. 7, which is an example of another interface accessible by the user. Users are able to select from additional pull-down menus at this interface 700 that include at least Metrics, Individuals, Measurements, Timeline, and Search pull-downs. FIG. 7 shows the Metrics 710 pull-down, which provides the Metric Name 720, Metric Description 730, Metric Calculation 740, and Metric History 750.

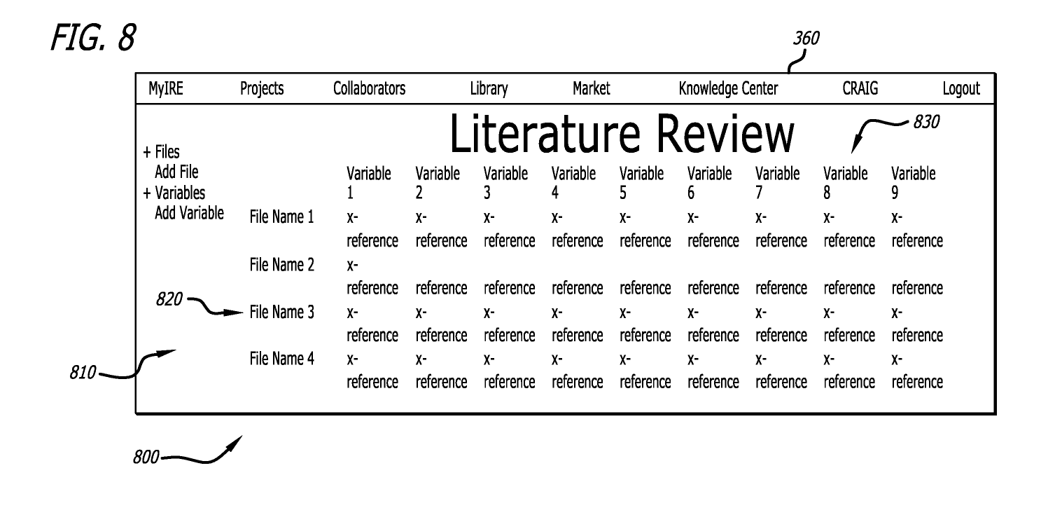

FIG. 8 is an example of a Literature Review interface 800, also accessible from the Project interface 500 of FIG. 5 via the Documents section. Such a Literature Review interface 800 presents users with a table 810 resulting from linked data structures 120 identifying specific file names 820 of background research and the various variables 830 provided for the one or more experiments 230 in the scientific research project 200. This presents another example of how data input into the present invention is manipulated to provide a background research library and literature review 210, as noted in FIG. 2, using linked data structures 120 and relationships 116 with variables 112 as the one or more experiments 230 in the scientific research project 200 are developed in the preset invention.

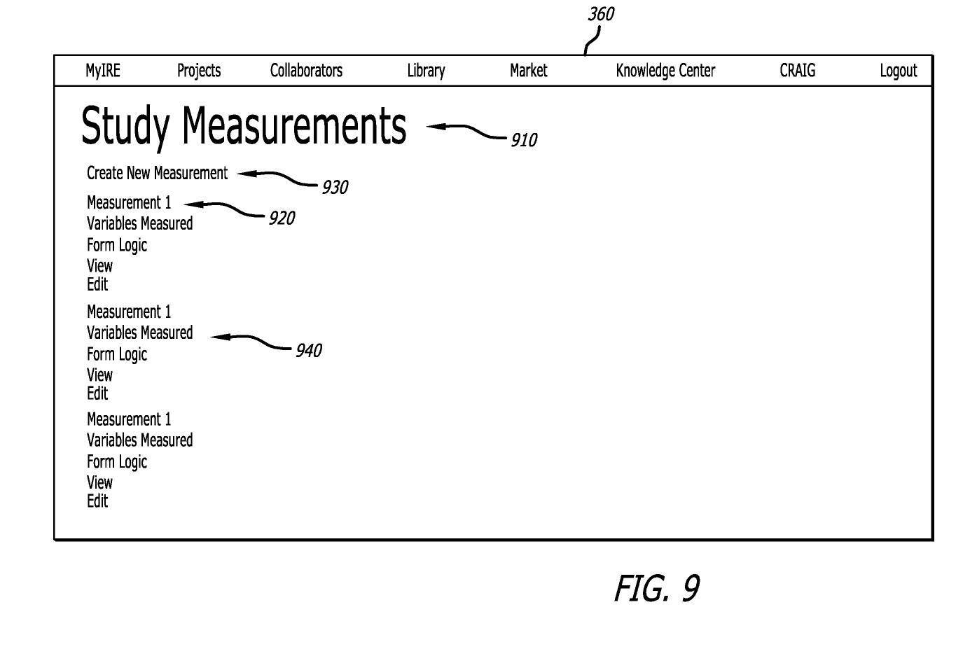

FIG. 9 is still another example of a further interface 900 available for users to view quantified data 280. Interface 900, accessible by the user from interface 500 by selecting the measurement documents link from the Documents section 510, presents the user with Study Measurements 910 and selectable information relating to measurements 920 performed. Users 114 are also able to create new measurements by selecting a Create New Measurement link 930 relating selectable variables 940 with data processing functions from one or more statistical measures 270, as shown in FIG. 2.

Other pull-down menus 360 available at any user interface of the online portal to the user allow for verification and publication of quantifiable results 280 of the one or more experiments 230. For example, the user may access the Collaborators pull-down from any interface to arrive at a list of users who have been granted access to participate in one or more aspects of the scientific research project 200. Users may utilize this section of the present invention to communicate with each other, assign responsibilities, review projects, provide comment about the one or more experiments 230, and perform other tasks such as apply further data processing functions and/or statistical analyses 270 to compare resulting experiment data.

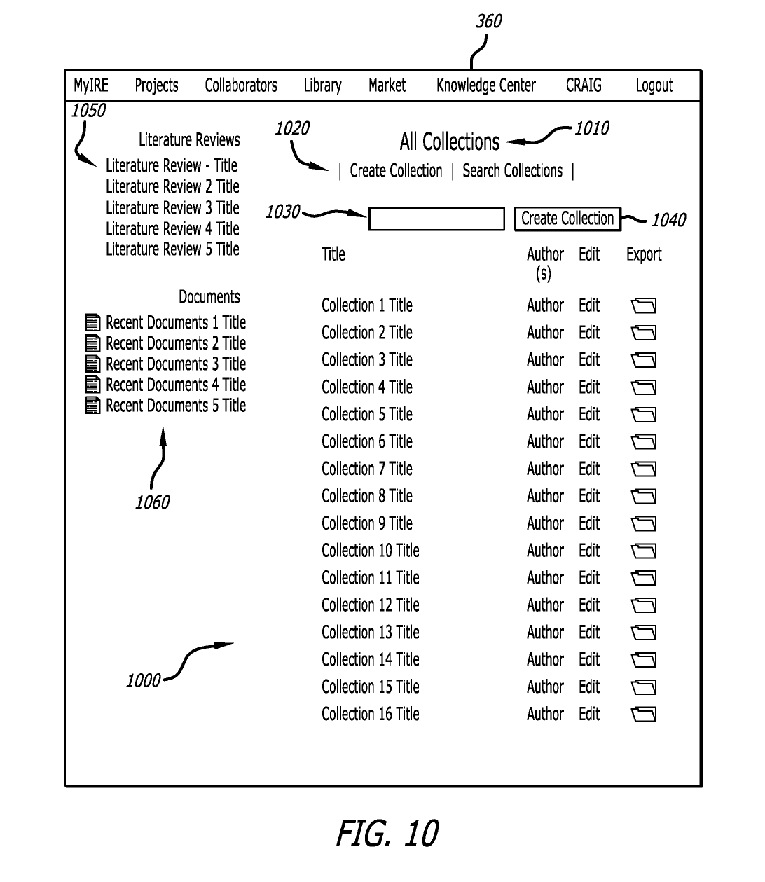

Further pull-down menus 360 permit the multiple users to finalize and publish experimental results 280 to add to the existing body of scientific knowledge. For example, as shown in interface 1000 in FIG. 10, users may utilize a Collections section 1010, accessed from the Library pull-down menu, to review collections and create further collections. Selecting the Create Collection 1020 item opens a window were users can identify a new collection in the Create Collection box 1030 and Create Collection button 1040. As noted above regarding FIG. 1 and FIG. 2, a publication module 108 translates resulting experimental data 280 into words, which then populate articles, papers, and other documents which become part of the existing background knowledge for further researchers to use as the basis for additional experiments and scientific research projects. FIG. 10 also shows the ability to select from a list 1050 of literature reviews 230 and recent document 1060.

Yet another pull-down menu 360 permits users to perform artificial intelligence functions in the present invention. In one embodiment, one such artificial intelligence function, known as CRAIG, or Computerized Research Artificial Intelligence Guide, is a module of the present invention that accepts input data from the integrated scientific research environment 100 and performs multiple data processing functions to provide output at specified intervals. CRAIG operates in the background to process input data and generate for example, suggestions about the scientific research project 200 at pre-determined times. Another example of such data processing functions enables running of queries over input data entered into the one or more experiments 230. Regardless, CRAIG is contemplated to be a module for performing data processing functions to generate specific output data for the present invention.

In the present invention, the literature review module 102 builds the background research library 210 as researchers conduct the background research for a topic to be a subject of the one or more experiments 230 in the scientific research project 200. In such a project, researchers base their scientific research on the findings and methods of already-existing published scientific articles. The integrated scientific research environment 100 allows researchers to find these published scientific articles, compare prior findings and methods with the results of the one or more experiments 230 being conducted, and create documents 260 recording the comparisons for publication or for guiding a future experiment. To accomplish the step of finding or searching for already-existing published scientific articles, the present invention may include a search engine which queries existing databases of scientific research articles such as, for example, PubMed, Medline, and Google Scholar, and saves them as part of data input into the system and method of the present invention. Such published scientific research articles are typically saved and stored in PDF format, but the present invention contemplates that any type of file format now known are to be developed may be utilized.

From these search results, researchers may transfer articles into the integrated scientific research environment 100 with a single click on a user interface. Articles transferred to the integrated scientific research environment 100 are available for further organization into groups and later access from any online portal or downloading to a personal computer or other mobile computing or telephony device, such as a desktop, laptop, smartphone, personal digital assistant, or tablet. Because the integrated scientific research environment 100 of the present invention is web-based, researchers have constant on-demand access to their entire library of background research from any online portal.

With a background research library populated, the integrated scientific research environment 100 and literature review module 102 provide users with the ability to create a literature review 210. A literature review 210 according to the present invention is a spreadsheet-like comparison of research articles and information contained within them. This information can be categorized by a type of finding or method contained in a particular research article. The literature review module 102 also provides users with the ability to view articles, and with functions to annotate the literature review 210, such as creating labels for these categories, entering digital notes about the article, and categorizing those notes for comparison across multiple articles.

These notes and comparisons are later included as cited references in a published scientific article. Literature reviews 210 are also commonly published as scientific articles themselves. The integrated scientific research environment 100 is also capable of extracting citation information from each article in a literature review 210 and managing them in a document, similar to Endnote or Zotero. The integrated scientific research environment 100 includes this document editing functionality, which is similar to that provided by commercially-available word processors such as Microsoft Word or GoogleDocs. The user can then export this document for formatting and submission to scientific journals.

The literature review module 102 allows researchers to use the notes and comparisons created in literature reviews 210 to make predictions about relationships 116 of variables 112 and methods to test those relationships 116 in the present invention. These predictions are mathematically embodied and tested by performing the one or more experiments 230 in the integrated scientific research environment 100.

Within the integrated scientific research environment 100, the research protocol building module 104 generates the research protocol 240 which provides a framework for performing the one or more experiments 230. In a typical scientific research project, researchers test predictions by systematically defining variables which represent the idea being tested, a group of tests subjects that embody the variables (including, for example, people, animal, or chemicals), measurements to quantify the variables and test subjects, and the time course of those measurements. After the definitions of variables, test subjects, and measurements are generated, the researcher procures resources to implement the plan. With appropriate resources, researchers implement the plan through conducting quantifiable measurements in the physical world and test the mathematical relationship of their quantified measurements through statistical analysis.

These processes are common to all experiments following the scientific method. Within the integrate scientific research environment 100, the research protocol building module 104 generates the research protocol 240 which provides a framework for a standardized set of functions for performing the one or more experiments 230. This standardized set of functions manages workflow and allows for customization of the one or more experiments 230 to individual needs.

The process of performing experiments 230, and definitions described above, are systematic and generally proceed according to a specific framework for any given experiment 230. The research protocol building module 104 of the integrated scientific research environment 100 allows for the creation of a document comprising the above framework, called a research protocol 240. The integrated scientific research environment 100 provides document editing functions with a standard format and set of input categories that allow the user to explicitly define the variables being tested, test subjects embodying the variables 112, measurements to quantify the variables 112 and test subjects, and the time course of those measurements.

The research protocol 240 therefore comprises data entered as a series of steps and the time course of those steps. Later, each step or series of steps can be assigned to individual users among the multiple users of the integrated scientific research environment 100. This allows for a multi-user research study to be divided amongst users for collaboration, and for each user to monitor their progress against a timeframe for completion of the one or more experiments. It also allows a researcher to monitor their adherence to the timeframe, as the date of measurement data input is checked against the timeframe. The research protocol 240 is capable of being shared with others performing the research, so that each user performs the same steps. The integrated scientific research environment 100 maintains a record of all changes to the research protocol 240 so that it can be referenced later.

Before implementing the proposed research protocol 240, a user first procures required resources such as materials, measurement methods, and personnel, where necessary. The integrated scientific research environment 100 allows the user to create a budget document listing these required materials. The research protocol building module 104 of the present invention may therefore include a budget generation module that generates the budget document.

Where the one or more experiments 230 are larger in scale and/or more complex, they often require funding to procure required resources. Funding is usually obtained from external resources through one or more grants. Researchers therefore prepare grant applications that commonly request credentials to prove researchers possess the capability to do the research, justification of the research through published background knowledge, a budget, and a detailed research plan. These credentials are typically embodied by a resume or curriculum vitae, or CV. The integrated scientific research environment 100 provides users with the capability to prepare to manage their resume or CV as part of a user profile. The preset invention provides functions such as importing a resume or CV and combining it together with the budget document detailed research plan into a single document. The user can then export this document and format it to the requirements of any particular grant application, thereby providing the capability to generate applications such external funding resources from within the integrated scientific research environment 100.

As noted above, users define test subjects among the variables 112 needed for the one or more experiments 230. Research involving animals and humans has special ethical considerations, and may require approval by an independent ethics committee, known as an Institutional Review Board, or IRB. The present invention includes an ethical document generator that allows users to create an application document for submission to the IRB. Such IRB application documents outline the steps taken to maximize safety and minimize ethical concerns for involved individuals or animals. The user can then export and format the IRB application document to the particular formatting requested by the particular IRB to which they apply.

Research involving humans also requires their informed consent as part of satisfying ethical requirements prior to beginning the one or more experiments 230. This process is also governed by the ethical document generator of the present invention, which prepares a set of scripted actions described by the researcher and a document to be signed by the participant individual.

Additionally, before the researcher can begin collecting data, he or she first generates a body of participant individuals on which to perform measurements. The researcher creates a profile for each participant individual to be tested in the one or more experiments. The researcher also creates a set of common criteria describing the participant individuals and may limit the study population to specific groups of participant individuals as needed. Regardless, all measurements and their time course are linked to the profile of the relative participant individual.

Locating participant individuals is known as recruitment, and includes keeping track of the participant individuals through their contact information, which may also be included in a profile. For research involving anything other than humans, researchers may purchase the test subject, such as an animal or chemical. In recruitment, the researcher creates a single set of recruitment criteria to check against the defined description of the study population. The research protocol module 104 of the present invention then creates a document called a recruitment protocol that outlines specific methods of contact and advertisement for participant individuals.

Researchers then contact the participant individuals and ensure they have the required criteria. This process can involve paper, phone, and digital methods. For paper methods, the present invention provides a method to create and print letters and advertisements using information such as name and contact information entered into individual's profiles on a mass scale. For digital recruitment, the research protocol module 104 converts the recruitment requirements to a web form which may be made available to the public. The present invention may also organize an initial online or physical-world “screening” visit for study participants, where some sort of testing is performed to ensure they meet study criteria.

Recruitment monitoring may be a requirement of the IRB. The research protocol 104 of the integrated scientific research environment 100 is therefore configured to track contacts with a participant individual using an input, and to create reports about progress. These reports are useful for monitoring the one or more experiments 230 being performed on the study population, and are also capable of being submitted to the IRB by the research protocol module 104 of the present invention.

Once the variables have been defined, the researcher then performs measurements according to the research protocol 240. These measurements are quantified in order to later analyze them with statistical analysis 270. The present invention allows users to create inputs for these measurements and their time course and allowable variability. These data inputs may take many forms, and may contain check boxes, alphanumeric entries, and graphical inputs. Users may be presented with a form generator for each measurement in the user interface of the online portal. This form can be digitally edited and printed. Once printed and filled out, the integrated scientific research environment 100 allows scanned forms to be input, and converts the resulting digital form into the sets of quantified measurements it represents and inputs this information into the one or more database locations 118.

Input from scanned and manual entry may also be checked for internal consistency. The researcher may define a set of logical data checks for automatic checking by research protocol module 104. Each time data is entered or changed the integrated scientific research environment 100 performs these checks. The logical data checks may be selectable statistical or other data processing measures 270 that analyze data for consistency. Additionally, any missing data or failed logical checks create an error report, which the researcher can view and make changes to data in the one or more database locations 118, together with notations of reasons for the change. All versions of the input data from measurements are logged and recorded, so that both changes and input data have a time course and may be checked using statistical measures 270 for consistency.

As data is input into the integrated scientific research environment 100, its relationships 118 are analyzed through the one or more statistical measures 270. The integrated scientific research environment 100 further includes a statistical analysis package which allows users to select data to test, as well as tests to perform on the quantified data. Within the integrate scientific research environment 100, the verification module 106 and publication module 108 are configured to provide a vehicle for analysis and comparison of results 280, and for generating publications to add to existing scientific knowledge on the subject of the one or more experiments 230 and the scientific research project 200.

As noted herein, the present invention contemplates that results are to be shared with other researchers to enhance the utility of the results for the scientific community. In the integrated scientific research environment 100, publication of results in scientific journals increases the body of scientific knowledge and provides the basis for future scientific research projects. The data sharing functions of the present invention enable researchers to add to the existing scientific knowledge through paper publication in both external publications as well as in a database that is part of the integrated scientific research environment 100.

Similar to the creation and publication of a literature review 210, the integrated scientific research environment 100 allows for the creation of one or more documents 260 comprising the publication. Document editing features are available within the present invention including the capability to generate images, figures and tables from experimental results 280. Also, the integrated scientific research environment 100 allows citations and statistical analysis to be imported from different sources within the integrated scientific research environment 100, such as the literature review 210, in a number of standard formats, the particularities of which may be changed as needed using graphical user interfaces. The publication document can then be exported and formatted to apply for publication in any scientific journal.

Additionally, users may choose to publish their research papers and share the actual resulting data set 280 within the integrated scientific research environment 100. The present invention tracks the entire research process and every event in the one or more experiments in a standard way, and allows publication of this information as a structured timeline of events. As part of the publication aspect of the present invention, researchers writing papers can reference the events in the one or more experiments 230 and selectively allow other users to create references within their respective publications to the these events.

Users may also upload finalized data sets, either selectively or in total. Because of the linked data structures 120, the present invention understands where sensitive or confidential data is resident, and automatically removes this data from the published documents. Nevertheless, prompts may be provided to the user to perform a check of the published data set to ensure such confidential information is not inadvertently disclosed.

In a verification aspect of the present invention, resulting data 280 may be presented in, for example, a Wikipedia article or similar format. Other users can click on reference words and be transferred to the study events timeline which lists the event as the present invention contemplated it. Users can then enter questions, comments, and ratings about methods, results, and events. Each reference may have a particular area of expertise associated with it, such as a particular statistical method of analysis, experimental implementation, or measurement method.

The verification component of the present invention further contemplates that both publications and users may receive a numerical rating by other users. Publication ratings may corresponds to both other researcher citation of the publication in external journals and the database of the integrated scientific research environment 100, as well as the weighted ratings of the users themselves who critique each publication.

Users may be rated by each other based on their contributions to a particular area of expertise. Users may give their approval or disapproval to a particular method, result, or event, using a simple gesture such as for example an electronic “thumbs up” or “thumbs down” rating system. Publications are then based on the cumulative weighted rating of all its user-critics.

At the core of the integrated scientific research environment 100 are linked data structures 120, which each of which is comprised of a set of data records, or nodes, linked together and organized by references such links or pointers. As noted herein, the linked data structures 120 represent different types of data entered by users, include the input data representative of an idea for experiment 110, as well as input data representative of background knowledge of the scientific research project 200. Linking permits the structured data inputs 250 to be processed with the one or more statistical measures 270 identified by and selected by the multiple users to translate them into quantifiable results 280 that are understandable and actionable by those conducting the one or more experiments 230. This results in a quantifiable and verifiable data collection, which is further structured into experimental results data 280 by the verification module 104 as further data processing functions 260 are applied to assess elemental relationships among the data.

Linked data structures 120 in the present invention therefore enable many functions. At the literature review level, they standardize the process of a literature review 210 by precisely defining what a user means by a particular label, form the basis of a literature review meta cognitive processor and deductive inference integrator engine, which in one embodiment perform many of the tasks of the literature review module 102. A literature review meta cognitive processor according to one embodiment of the present invention is a component which recursively and iteratively analyzes literature reviews 210 to predict future areas of research, suggests additional articles and variables to consider, and measures internal validity of all literature reviews 210 in the integrated scientific research environment 100.

At the research protocol level, data structures 120 also allow the present invention to translate defined variables into a research protocol 240. Each variable is structured in, for example, a Wikipedia-style definition system. The definition may include a text description of what the variable 112 means, a list of best practices for measuring the variable 112, a list of best practices for identifying the variable 112 in published studies, and lists of links to more specific and/or more generic and related variables which the user may want to use instead of their selected variables 112.

Variables 112, as noted herein, are measured in many different things, including but limited to non-physiological entities or physiological entities such as participant individuals, animals, chemicals, or other biological items to be tested that embody them. Variables 112 in an experiment 230 cannot be measured without having someone or something to embody it. The group of participant items, individuals, animals, chemicals, and biological entities such as, for example, biomolecules, viruses, and bacteria that embody the defined variables is termed a study population. It is important to note that study populations are not to be limited to physiological bodies, and therefore, depending on the type of experiment 230, the study population may include other non-physiological participant bodies, such as for example existing numerical data sets or experimental observations, or planets. Additionally, the study population may be defined in terms of one or more subsets of data categories.

Variables 112 relating to study populations in the present invention may also be structured in a Wikipedia-style definition system. The definition includes a text description of what the study population includes, a list of best practices for defining what the study population represents, a list of best practices for identifying the study population in published studies, and lists of links to more specific and/or generic and related variables which the user may want to use instead of their selected study population.

Users may also define relationships 116 between variables 112. Similar to other linked data structures 120 in the present invention, such relationships 116 may be structured in a Wikipedia-style definition system. The definition includes a text description of what the relationship 116 represents, a list of best practices for establishing each relationship 116, a list of best practices for identifying the relationship 116 in published studies, and lists of links to more specific and/or generic and related relationships 116 which the user may want to use instead of their selected relationships 116.

Methods of measuring data input in the integrated scientific research environment 100 are also defined variables 112 in the present invention. Data relating to variables 112 in methods of measurement may also be structured in a Wikipedia-style definition system. The definition includes a text description of what the measurement method represents, a list of best practices for implementation of each method of measurement, sources and significance of error in use of each method of measurement, a list of best practices for identifying the method of measurement in published studies, lists of links to more specific and/or generic and related methods of measurement which the user may want to use instead of their selected methods of measurement, the actual implementation of the measurement method's interface in the integrated scientific research environment 100, and a list of studies implementing the methods of measurement.

Study events in the present invention are representations of user actions in the outside world which do not involve measurement of a variable. These typically include interventions by the user conducting an experiment 230, or recruitment events. Study events may be considered measurements in a binary form, such as for example in the form of interventions may be done or not, and recruitment events may be done or not.

Linked data structures 120 of study events in the present invention may be structured similar to other variables in a Wikipedia-style definition system. The definition includes a text description of what the study event represents, a list of best practices for implementation, sources and significance of error in the use of study events, a list of best practices for identifying the study event in published studies, lists of links to more specific and/or generic and related study events which the user may want to use instead of their selected study event, the actual implementation of the study event's interface in the integrate scientific research environment 100, and a list of studies implementing the study event.

In one embodiment of the present invention, the integrated scientific research environment 100 includes an idea notebook feature, which is a small digital notepad where researchers can quickly add notes about existing scientific research projects 100, and ideas for new ones. These notes may come from prior knowledge, achieved through education, experimentation, and current observation. The purpose of these notes is to define a question about how the world works (i.e. how variables embodied in the world are related). The researcher can categorize these notes under headings, and select one or more to convert to a project. By selecting one or more notes, these notes are copied or moved to the project notebook, and a new project is created.

Ideas generated by the researcher in system components such as the idea notebook feature are first given structure in the literature review 210. The literature review 210 involves analysis of available data published in research studies across a set of comparison categories. Published research data are usually found .pdf file formats and may include text, graphics, figures, tables, etc, but may also be found in any other known or future file formats. The literature review module 102 of the integrated scientific research environment 100 creates this structure by performing, in one embodiment, a series of steps. These steps may include searching for published experimental results in research articles, storing and organizing articles found in the search, creating categories to compare published articles, classifying study information into the comparison categories created, and generalizing the results of their comparisons to form a hypothesis.

The literature review module 102 includes a search engine configured to search existing publications for published experimental results and on the variables 112 and idea or topic on which the one or more experiments 230 will be based. The search engine interfaces with external databases of scientific documents, the one or more database locations 118 of the integrated scientific research environment 100 itself, and may also search a researcher's local or network hard drive or specific folders thereon. Other functions may also be implemented, such as for example allowing a researcher who is reading a digital file of an article to click citation information in that file related to a cited article therein to search for that cited article.

The literature review module 102 also includes the ability to store and organize articles found in searches. Researchers can input articles into the integrated scientific research environment 100 from the search engine, from pre-existing organizational programs such as Mendley or GoogleDocs, or from their own computing device. Uploaded articles may be converted to a viewable representation compatible with output data of the present invention to be analyzed for citation information. When the article is uploaded, it is read by the literature review module 102 and citation information is automatically extracted. This citation information can later be exported in any format.

All articles uploaded to the integrated scientific research environment 100 go into a central “folder” or library. The library is searchable, sortable and organizable using common user interface methods like drag and drop. Additional organization is provided by collections and literature reviews. Collections are arbitrary labels for organization “folders” of a group of articles that the user believes are similar.

Literature reviews 210 may also be considered as labels for a specific set of files, which are associated with a specific set of functions. The information in articles organized into literature reviews 210 is entered in a structured fashion in order to form the hypothesis of the one or more experiments 230 and form the basis of logical deductions performed by the literature review meta cognitive processor of the literature review module 102.

The literature review module 102 also allows the researcher to create a list of comparison categories for information found in the articles which comprise a literature review 210. These comparison categories have labels that are usually selected from a set of labels. Typically, these comparison categories include methods described in the study, results, number of data points, and statistical analysis methods. The user may also provide a custom input of a variable for a particular literature review 210.

The literature review module 102 also allows the user to classify study information into the comparison categories created. Articles in the literature review 210 are analyzed for results, methods, implementations of methods and the logical rationale for each of those in the study. This is done in a process called annotation, in which articles added to a literature review 210 are available for viewing, reading, and adding notes to articles. Each note has one or more associated variables assigned to it.

Documents in this annotation process are viewed using software such as for example Google docs or a PDF reader. When a researcher clicks on a particular section of text, the present invention extracts that location and allows the user to input text. The user inputs text and assigns one or more variables which describe what the information contains. Additionally, if the particular annotation refers to a variable 112 or method in the linked data structures 120, it links this information with the annotation.

The literature review module 102 may also generalize the results of comparisons to form a hypothesis 220. In order to generalize comparisons of individual articles, the present invention creates a spreadsheet-like representation of articles and variables 112. Data may be populated therein in many different ways—for example, row headings and column headings may be file names or variable names, and each cell may include the individual annotation created as above. Each cell may also include the text of the annotation and a link to click to view the particular annotation location in the document. The researcher may apply deductive and inductive logic to these comparisons in order to create a hypothesis 220 to direct the one or more experiments 230 to be conducted in the scientific research project 200.

The hypothesis 220 provides a definition 114 of variables 112 and relationships 118 which will be studied in the one or more experiments 230. The integrated scientific research project 100 allows the researcher to select the variables 112 and relationships 116 to be examined in the hypothesis 220 from the lists of variables and relationships. By entering this information into the integrated scientific research environment 100, it allows the hypothesis 220 to be checked using the literature review meta cognitive processor, and it allows the integrated scientific research project 100 to suggest additional articles and variables 112 to consider.

The hypothesis 220 generated by entering data and formulating a literature review 210 is further structured into a plan for experimental data collection in an experiment planner created by the research protocol building module 104. This plan comprises variables 112, methods of measurement, study events, statistical analysis methods 270, and a study timeline. This information is compiled into a single document in the integrated scientific research environment 100 in the form of the research protocol 240.

The research protocol building module 104 of the integrated scientific research environment 100 uses the hypothesis 220, variables 112, relationships 116, the literature review meta cognitive processor, research interests, and progressive user input to suggests ways to design the one or more experiments 230 in the plan. The integrated scientific research environment 100 also uses information from the experiment planner to structure the one or more database locations 118 and tables as well as database triggers for particular inputs.

The integrated scientific research environment 100 may provide researchers with selectable lists of variables 112 and other data, or the user may input customized variables 112 of his or her own. Regardless of whether selected from the integrated scientific research environment 100 itself or entered separately, the research protocol 240 is formulated from defined variables such as independent and dependent variables 112, study populations, and sample sizes. Methods of measurements may also be selected from the integrated scientific research environment 100 or entered as data input, and may include study events, study timelines, and time variation allowances. Study events and timelines may be input as calendar or in form, and time variation allowances result from user definitions of the maximum allowable time variation for each study event and measurement as well as instructions for if and when the variation is exceeded.

The researcher also selects the inferential and descriptive data processing functions 260 to be applied from a statistical analysis portion of database location 118 of the integrated scientific research environment 100. The researcher may also create a new statistical method 260 by entering it into the one or more interfaces of the integrated scientific research environment 100. Regardless, these data processing functions 260, which at least involve applying statistical tests to the structured data 250 embodied by defined variables 112 and relationships 116, form the basis for analyzing and processing data in the one or more experiments 230.

A user may also select statistical significance criterion for each test used. If no significance criterion is defined by the user, the integrated scientific research environment 100 may default to a specific level, such as for example 5%. From the statistical significance criterion, the sample size, the statistical test to be used, and the magnitude of the effect of interest in the study population, the integrated scientific research environment 100 conducts a prospective power analysis test. The integrated scientific research environment 100 uses the power analysis and proposed research protocol 240 to predict the likely number of participant individuals needed to be recruited in order to achieve a significant effect.

The research protocol building module 104 of the integrated scientific research environment 100 includes an IRB manager. If the user's study population comprises humans or animals on which the one or more experiments 230 will be performed, the IRB manager of the research protocol building module 104 prompts the user to create an IRB application document and manages correspondence with the IRB. The IRB application document describes methods for generating the list of potential participant individuals or animals, methods for communicating with potential participant individuals, specific timelines of study events risks and benefits of the experiment 230 to the involved participant individuals, protections put in place to maximize participant safety, protections put in place to minimize ethical concerns, and a list of potential adverse events.

The application document typically utilizes a standard template format created by the particular IRB itself. There integrated scientific research environment 100 offers suggestions for IRB guidelines; however each institution's IRB is different, and there is no standard set of IRB requirements.

The IRB may approve, reject, or send and application back with required modifications to the research protocol prior to approval. Afterwards, there is likely to be continuous back and forth communication between the researcher and the IRB to monitor study progress, report events that could harm the animal or humans being studied, and report deviations from approved procedures in the approved protocol. Communication with the IRB may be done using paper, phone calls, email, and online software specifically tailored for the specific IRB. Typically, IRB communication is a combination of all of these; however there must be a record of IRB interactions for compliance with national regulations.

Before implementing the research protocol 240, a researcher first procures the required resources. Depending on the size, complexity, and type of experiment, required resources may vary widely. However, there are common categories of resources that are required to implement the research protocol 240, such as resources for including participant individuals embodying the variables of interest, for implementing proposed research methods, for data collection, for data storage, and for data analysis. The research protocol module 104 may include a procurement module for managing procurement of resources for the one or more experiments 230.

The integrated scientific research environment 100 and research protocol module 104 may further include a grant management module that oversees solicitation of funds from to meet budget requirements for the one or more experiments 220. It is contemplated that the present invention may apply a small fee to the researcher, and may represent a percentage of the grant amount procured, for such a grant management service.

When applying for grant funding, a researcher typically writes one or more grant applications. The grant application module may include a grant writing function to prepare grant applications, which may incorporate credentials to demonstrate that the researcher is qualified to conduct the one or more experiments 230, and include a description of the proposed benefit of the one or more experiments 230, a copy of the research protocol 240, and a budget detailing the required financial costs of the scientific research project 200.

The integrated scientific research environment 100 allows for researchers to create inputs for measurements to be performed, as well as their time course and allowable tolerances, in many different forms. Measurements may be input by typing or entering data into interfaces or by scanning one or more documents, or via another alphanumeric or graphical input. In one embodiment, the present invention contemplates a form generator for each measurement, which can be digitally edited and printed. Once printed and filled out, the present invention allows scanned forms to become input data, converts the scanned digital form into the sets of quantified measurements it represents. This information is then provided to the one or more database locations 118 to serve as a guide to the one or more experiments 230 via the research protocol 240.

Input from scanned or manual data entry is made available for checking for internal consistency. The researcher may define a set of logical checks for automatic checking in the integrated scientific research environment 100. Each time data is entered or changed, the present invention performs these logical checks, which may be through the one or more statistical analytics 260. Additionally, any missing data or failed logical checks create an error report. The researcher can view and change data in the database 118 based on such error report, and note reasons for the change. All versions of the input data from measurements are logged, so that both changes and input data have a time course and may be checked using the statistical analytics 260 for internal consistency.

Therefore, as quantified data is input into the integrated scientific research environment 100, its relationships 116 are analyzed through the one or more statistical analytics 260 of the linked data structures 120. The integrated scientific research environment 100 includes a statistical analytics module which allows the user to select data to test and the statistical analytics 260 to be performed.

The integrated scientific research environment 100 also tracks status metrics and task reminders, and may structure data in the one or more database locations 118 to suggest ways to implement the scientific project 200 being conducted. Project status metrics are numerical indicators used to monitor experiment progress along a timeline for conducting the scientific research project 200. Each researcher can customize a metric used to monitor project status from a number of commonly-used and available metrics. Users can also create custom metrics by creating an equation of information categories from the research study. This is similar to the process of inputting an equation to excel or other spreadsheeting software where information categories represent rows, columns, or pages of the spreadsheet. The present invention then uses the user-input equation to calculate the project status metric desired.

Statistical analytics requires numerical information to perform tests. Thus, each measurement must be numerically quantified. Common quantification methods include nominal, ordinal, interval, and ratio data. Each of these have different degrees of usefulness in statistical analytics. Ratio measurements, for example have both a meaningful zero value, the distances between different measurements are defined. They provide the greatest flexibility in statistical methods that can be used for analyzing the data. Interval measurements have meaningful distances between measurements defined, but the zero value is arbitrary. Examples of this include longitude and temperature measurements in Celsius or Fahrenheit. Ordinal measurements have imprecise differences between consecutive values, but have a meaningful order to those values. Nominal measurements have no meaningful rank order among values.

Because variables conforming only to nominal or ordinal measurements cannot be reasonably measured numerically, sometimes they are grouped together as categorical variables, whereas ratio and interval measurements are grouped together as quantitative variables, which can be either discrete or continuous, due to their numerical nature. Data analysis uses inferential and descriptive statistics to mathematically describe the relationship in measured variables. Inferential statistics measure the probability that the measured relationship is due to chance. Descriptive statistics estimate the magnitude or practical importance of the difference in measurements.

The publication module 108 of the present invention is responsible for compiling the measured, tested data now embodied in quantifiable results 280 and preparing for one or more publications 290. Although there is no standard format for submission of such publications 290, the integrated scientific research environment 100 prepares information and sections typically found in most of such publications 290, and incorporates document editing functionality allowing customization of the publication 290. Examples of sections of a publication created include the abstract, introduction, materials and method, results, discussion and conclusion, and works cited. The publication module 108 is configured to populate each of these sections with information stored in the one or more database locations 118. For example, the materials and methods portion of a publication 290 may follow a summary of the research protocol 240, and the works cited section may be a summary of the literature review 210.

The present invention may also, in another embodiment, incorporate pay-per-access fee structures allowing users to pay a subscription fee for the ability to upload full data sets and scientific articles, have them peer reviewed, and access the full body of information uploaded to the integrated scientific research environment 100. Additional functionality may allow a researcher to choose to share that article and data set for free, or set a price for all or parts of it. Users may then be able to purchase credits in the integrated scientific research environment 100, which are used to pay for article access. The author would receive a percentage of each sale, with the integrated scientific research environment 100 taking a transaction fee per sale. This process monetarily incentivizes high quality research at an individualized level.

The present invention may utilize a distributed computing infrastructure, and within such an infrastructure, different computing architecture, designed to spread computational power around multiple computing environments in a distributed fashion to perform the multiple processes needed to host and perform the present invention. It is to be understood that many different configurations are possible and contemplated within present invention. For example, the present invention may employ cloud computing principles and technology to provide a distributed platform and resources for hosting multiple modules and data access, processing, modeling, and storage, as well as communication between system components, so that no one portion is required to host, process, or store information. The distributed computing infrastructure may also be thought as a grid computing architecture in which middleware provides the link between the various modules of the present invention to facilitate distributed data processing. Regardless, the present invention may employ a cloud-based or grid-based distributed computing infrastructure in multiple ways to meet the operational functions and objectives disclosed herein. Additionally, it is to be understood that communications with the distributed computing infrastructure may be through both wired and wireless means, and that users may access the present invention from both wired and wireless or mobile platforms.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. For example, the present invention may include communication with a surplus property exchange for procuring experiment resources, and support for external consulting services that may perform tasks such as contract research services that are attendant to performing the one or more experiments 230 in a scientific research project 200. The present invention may further include the ability to facilitate automatic procurement with one or more surplus property exchanges to quickly and easily obtain equipment needed for performing the one or more experiments 230. It is therefore intended that the scope of the invention be limited not by this detailed description.

1-6. (canceled)

7. A method of conducting standardized experiments in a collaborative scientific research project in a distributed computing infrastructure, comprising:
generating a background research library accessible by multiple users during conduct of one or more experiments in a scientific research project and creating a comparison of background research documents relative to the one or more experiments in the scientific research project from input data identifying the background research documents and representative of at least one category of information in the background research documents to be analyzed in conducting the one or more experiments in response to instructions provided for categorizing the background research library;
building a research protocol to guide conduct of the one or more experiments from input data representative of multiple input categories at least including experiment variables, participants, measurement methods, and time course;
creating a framework of structured data inputs by defining relationships between one or more variables in the input data representative of multiple input categories, in which one or more linked data structures relate an input category and its associated structured data with at least one other input category and its associated structured data according to one or more labels provided by a user, and relating the one or more linked data structures so that the defined relationships between one or more variables across the multiple input categories are standardized according to the one or more labels relating to the input category to the at least one other input category, wherein the defined relationships between the one or more variables are analyzed in one or more experiments in a scientific research project in which variables represent one or more measureable quantities in at least one of the research protocol and background research library;
performing analytical data processing on the input data representative of the multiple input categories in at least one processor within the distributed computing infrastructure, by applying one or more selected statistical measures to permit the one or more users to generate customized quantifiable results based upon one or more measurements and a comparison of the quantifiable results using one or more additional statistical measures so that the one or more experiments are collaboratively conducted in the scientific research project;
creating documents for organizing at least the input data representative of multiple input categories, the input data identifying the background research library, and the one or more measurements to be taken based upon the measurement methods from linked data structures so that the multiple users are capable of collaboratively reviewing, editing, analyzing and verifying the quantifiable results; and
publishing the quantifiable results to add to existing scientific knowledge relative to the scientific research project.

8. The method of claim 7, further comprising creating a list of cited references from the comparison of background research documents for publication of the quantifiable results of the scientific research project.

9. The method of claim 8, wherein the generating a background research library accessible users during conduct of one or more experiments in a scientific research project and creating a comparison of background research documents further comprises categorizing the background research documents according to a type of finding or a type of method discussed in each background research document, wherein each user in the multiple users is permitted to create category labels, view each background research document, input notes, and categorize the notes for inclusion in the comparison of background research documents.

10. The method of claim 7, wherein the creating a research protocol further comprises maintaining records of all changes to the documents.

11. The method of claim 7, wherein the creating a research protocol further comprises creating a budget for tracking materials to be used in the conduct of the one or more experiments, measurements, and participation required for conducting the scientific research project.

12. The method of claim 7, wherein the creating a research protocol further comprises generating one or more grant applications for procurement of funding for the scientific research project.

13. The method of claim 7, further comprising generating an application for approval from one or more oversight bodies for participants to take part in the one or more experiments.

14. The method of claim 7, further comprising generating a user profile and permitting each user to manage and edit the user profile.

15. The method of claim 7, further comprising generating a script for obtaining informed consent of individuals involved in the scientific research project and creating a consent document.

16-20. (canceled)
